(19) United States
(12) Patent Application Publication
(10) Pub. No.: US 2019/0118432 A1
(43) Pub. Date: Apr. 25, 2019

(54) BLOWING AGENT INTRODUCTION IN POLYMER FOAM PROCESSING

(71) Applicant: Trexel, Inc., Wilmington, MA (US)

(72) Inventors: Theodore A. Burnham, Melrose, MA (US); Brian S. Cockell, North Andover, MA (US); Samuel Edward Dix, Newton, NH (US); Levi A. Kishbaugh, Groveland, MA (US)

(73) Assignee: Trexel, Inc., Wilmington, MA (US)

(21) Appl. No.: 15/791,218

(22) Filed: Oct. 23, 2017

(51) Int. Cl. B29C 44/34; B29C 44/02; B29C 44/42; B29C 44/60

(52) U.S. Cl. CPC B29C 44/3446; B29C 44/02; B29K 2105/04; B29C 44/60; B29C 44/422

(57) ABSTRACT

Methods and systems of introducing blowing agent in a polymeric foam process are described. The methods and systems may be used to discontinuously introduce blowing agent in polymeric foam processes (e.g., injection molding processes) that discontinuously plasticate polymeric material.

### FIELD

The present invention relates generally to polymer foam processing and, more particularly, to methods and systems for introducing blowing agent in a polymeric foam process.

### BACKGROUND

Polymeric foams include a plurality of voids, also called cells, in a polymer matrix. Polymeric materials are processed using a variety of techniques. Many techniques employ an extruder which plasticates polymeric material by the rotation of a processing screw within a barrel. Some processing techniques, such as injection molding or blow molding, are discontinuous. That is, during operation, the screw does not plasticate polymeric material continuously throughout the molding cycle. For example, the screw may stop rotating after a charge of polymeric material mixed with blowing agent is accumulated downstream of the screw and, thus, ceases to plasticate polymeric material. The screw also may not rotate during an injection cycle when the screw moves in a downstream direction, for example, to inject polymeric material into a mold.

Polymeric foam materials can be processed by injecting a physical blowing agent into the polymeric material within the barrel. Many conventional blowing agent delivery systems inject blowing agents continuously into the polymeric material within the barrel. In discontinuous plastication processes, such continuous blowing agent delivery systems may inhibit control over the percent blowing agent injected into the polymeric material and may lead to an uneven distribution of the blowing agent in the polymeric melt. In particular, the polymeric material in the vicinity of the blowing agent port, when the screw ceases to plasticate polymeric material, may contain higher amounts of blowing agent because of its increased residence time in proximity with the blowing agent injection port. The uneven distribution of blowing agent may result in viscosity variations within the polymeric material which can cause output inconsistencies in the extruder and other problems. Such effects may reduce control over the process.

In some polymer processes, including some discontinuous processes, such conventional blowing agent delivery systems may be adequate. However, in other processes such as discontinuous processes that require relatively precise control over blowing agent delivery, the conventional systems may reduce the effectiveness of the process. For example, certain processes for producing microcellular polymeric foams may be adversely effected if the blowing agent is not precisely controlled.

Other conventional blowing agent delivery systems may discontinuously introduce blowing agent into the extruder by using a valve that closes to shut-off blowing agent flow during a portion of the molding cycle (e.g., during injection into a mold). The valve may be positioned proximate the blowing agent port in the extruder. The frequent opening and closing of the valve, however, may limit the lifetime of the delivery systems, particularly when used with molding processes that have short cycle times.

Accordingly, there is a need for new blowing agent introduction systems that may be used with discontinuous polymer processing techniques such as injection molding.

### SUMMARY

Methods and systems of introducing blowing agent in a polymeric foam process are described.

In one aspect, a method is provided for discontinuously introducing blowing agent into a discontinuous polymer foam processing system including an extruder. The method comprises providing a source configured to supply blowing agent to a flow restrictor of a blowing agent introduction system. The method further comprises measuring blowing agent pressure upstream of the flow restrictor and downstream of the flow restrictor. The method further comprises changing pressure of the blowing agent upstream of the flow restrictor using a pressure regulator to control introduction of blowing agent into polymeric material in the extruder of the discontinuous polymer foam processing system. Blowing agent is introduced into the polymeric material in the extruder when the pressure of the blowing agent upstream of the flow restrictor is greater than the pressure of the blowing agent downstream of the flow restrictor and blowing agent is not introduced into the polymeric material in the extruder when the pressure upstream of the flow restrictor is less than the pressure downstream of the flow restrictor.

In one aspect, a polymer foam processing system is provided. The system comprises a blowing agent source and a blowing agent introduction system connected to the blowing agent source. The blowing agent introduction system includes a flow restrictor, a pressure regulating device upstream of the flow restrictor; a pressure measuring device upstream of the flow restrictor and a pressure measuring device downstream of the flow restrictor. The system further comprises an extruder including a screw constructed and arranged to rotate within a barrel to convey polymeric material in a downstream direction. The barrel has a blowing agent port formed therein. The system further comprises a mold connected to an outlet of the extruder. The blowing agent introduction system is configured to introduce blowing agent into the polymeric material in the extruder when the pressure of blowing agent upstream of the flow restrictor is greater than the pressure of blowing agent downstream of the flow restrictor and blowing agent is not introduced into the polymeric material in the extruder when the pressure of blowing agent downstream of the flow restrictor is less than the pressure of blowing agent upstream of the flow restrictor.

Other aspects and features will become apparent from the following detailed description of the invention when considered in conjunction with the accompanying drawings.

### BRIEF DESCRIPTION OF THE DRAWINGS

FIG. 1 schematically illustrates a polymer foam processing system including a blowing agent introduction system according to an embodiment.

### DETAILED DESCRIPTION

Methods and systems of introducing blowing agent in a polymeric foam process are described. The methods may be used to discontinuously introduce blowing agent in discontinuous polymer processes (such as injection molding or blow molding) and may be particularly advantageous when used with processes that have short molding cycle times. Blowing agent introduction may be controlled by operation of a pressure regulator which controls blowing agent pressure within the system. The regulator may set blowing agent pressure within a desired range, as described further below, to introduce blowing agent into the extruder and, at the appropriate time, may decrease blowing agent pressure to prevent blowing agent from flowing agent into the extruder. The blowing agent introduction system includes a flow restrictor downstream of the pressure regulator. The systems and methods measure the flow of blowing agent into the polymeric material by measuring a pressure drop across the flow restrictor. As described further below, the flow and/or amount (e.g., mass) of blowing agent may be calculated from a pre-determined relationship between pressure drop, flow rate, flow element dimensions, and potentially other variables measured by the system (e.g., blowing agent temperature). In some embodiments, the methods involve diverting blowing agent flow to the extruder through a passageway back to the blowing agent source when the blowing agent is not being introduced into the extruder.

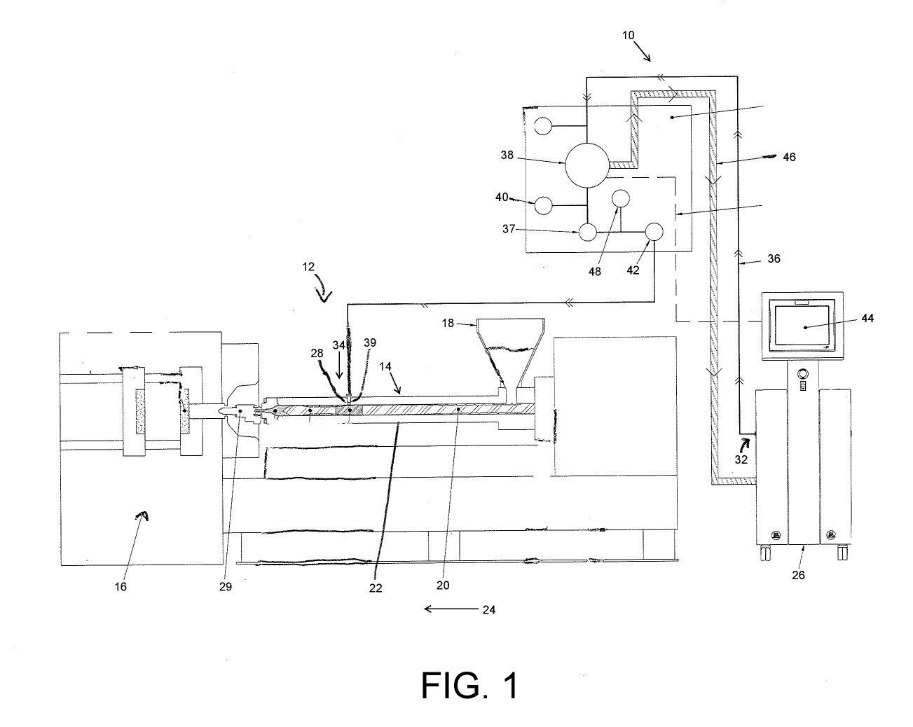

Referring to FIG. 1, a blowing agent introduction system 10 is used to deliver blowing agent to a polymer processing system 12. In this embodiment, system 12 is a discontinuous polymer processing system that includes an extruder 14 and a mold 16. As shown, a hopper 18 provides polymeric material (e.g., in the form of pellets) to the extruder. The extruder includes a screw 20 designed to rotate within a barrel 22 to plasticate polymeric material. Heat (e.g., provided by heaters on the extruder barrel) and shear forces (e.g., provided by the rotating screw) act to melt the polymeric material to form a fluid polymeric stream which is conveyed in a downstream direction 24 by rotation of the screw.

In the illustrated embodiment, the blowing agent introduction system 18 includes a physical blowing agent source 26 that is connected to one or more port(s) 28 in the barrel of the extruder. As described further below, system 18 controls the introduction of physical blowing agent from the source into the fluid polymeric stream in the extruder. When blowing agent is introduced into the fluid polymeric stream, a mixture is formed that is conveyed downstream in the extruder barrel. In some embodiments, the mixture is a single-phase solution with the physical blowing agent being dissolved in the polymeric material prior to injection into the mold. In the illustrated embodiment, a valve 29 is arranged between the outlet of the extruder and the inlet of the mold. The mixture (e.g., single-phase solution) may be accumulated downstream of the screw within the extruder causing the screw to retract in an upstream direction within the barrel. When suitable conditions have been reached (e.g., after a predetermined time period, at a predetermined screw position, after a predetermined amount (e.g., mass) of blowing agent introduced, etc.), as described further below, the blowing agent introduction system can operate to stop blowing agent introduction into the extruder. Typically around the time (e.g., slightly after) when blowing agent introduction ceases, the screw stops retracting and rotating to end the plastication period of the molding cycle. During the injection period of the molding cycle, the screw may be forced downstream within the barrel to inject the mixture into a cavity of the mold when valve 29 opens. The mixture is subjected to a pressure drop during injection which nucleates a large number of cells and a polymer foam article is formed in the mold. The screw may begin to rotate once again to begin another plastication period upon which the blowing agent introduction system operates to introduce blowing agent into polymeric material in the extruder. The method is typically repeated to produce multiple foam articles.

It should be understood that polymer foam processing system may include a number of conventional components not illustrated in the figure.

The blowing agent introduction system includes an upstream end 32 connectable to source 26 and a downstream end 34 connectable to port(s) 28. Conduit 36 extends from the upstream end to the downstream end to connect various components of the introduction system and to provide a pathway from the source to the blowing agent port. As noted above, the blowing agent introduction system includes a flow restrictor 37 through which blowing agent passes when flowing from the source to the blowing agent port. Upstream of the flow restrictor, the blowing agent introduction system includes a pressure regulator 38 and an upstream pressure measuring device 40. Downstream of the flow restrictor, the blowing agent introduction system includes a downstream pressure measuring device 42. A controller 44 of the blowing agent introduction system may be operably connected to the measuring devices and regulators, so that the controller may receive inputs from the measuring devices and can provide outputs to control the regulator. As shown, the system includes a return pathway 46 with an inlet upstream of the flow restrictor that enables blowing agent to flow back to the source when the blowing agent is not being introduced into the extruder.

In some embodiments and as shown, the blowing agent introduction system may optionally include one or more temperature measuring device 48. For example, temperature measuring device(s) may be positioned at one or more of the following locations: at or proximate the flow restrictor, upstream of the flow restrictor, or downstream of the flow restrictor. The temperature measuring device(s) may also be operatively connected to the controller so that the controller is responsive to inputs from the temperature measuring devices.

In some cases, the blowing agent introduction system may include a temperature controlling device (not illustrated). Such temperature controlling devices may be employed to heat or cool the blowing agent to a desired temperature. The temperature controlling devices may be located at one or more of the following locations: at or proximate the flow restrictor, upstream of the flow restrictor, or downstream of the flow restrictor. Temperature controlling devices are not used in many embodiments.

To measure the amount (e.g., mass) of blowing agent introduction (e.g., in a molding cycle and/or plastication period) and/or otherwise control blowing agent introduction, the blowing agent introduction system can utilize a relationship between the blowing agent pressure differential across the flow restrictor, the dimensions of the flow restrictor, the flow rate of blowing agent and, in some cases, the temperature of the blowing agent. Such a relationship may be pre-determined for a given flow restrictor using a calibration procedure. One suitable calibration procedure involves measuring the flow rate through the flow restrictor at a number of different pressure and temperature conditions. The dependency of flow rate on the flow restrictor dimensions and other measured variables may be determined, for example, using regression analysis as known to those of ordinary skill in the art. The measured variables may include pressure differential across the flow restrictor, upstream pressure, downstream pressure, and temperature of the blowing agent at one or more locations. In some embodiments, the relationship may be used by the controller to determine the amount of blowing agent introduced (e.g., in a molding cycle and/or plastication period) and/or how to regulate the pressure upstream of the flow restrictor to provide a desired blowing agent flow volume and/or rate in response to inputs from the measuring devices (e.g., pressure differential across the flow restrictor, temperature) and manual inputs (e.g., dimensions of the flow restrictor).

During an illustrative process, the source provides blowing agent to the introduction system. As blowing agent flows through the conduit, the upstream pressure is measured by device 40, the downstream pressure is measured by device 42, and the temperature of blowing agent at the flow restrictor is measured (optionally) by device 48. The pressure and temperature measuring devices send input signals to the controller. The controller processes such input signals along with other input signals (e.g., relating to screw position and operation, time in cycle, etc.), and sends suitable output signals to control operation of the pressure regulator. For example, when the screw begins to rotate at the onset of the plastication process, the controller sends an output signal to the pressure regulator to set the pressure of the blowing agent upstream of the flow restrictor to be above that of the pressure downstream of the flow restrictor (and also generally above that of the pressure of polymeric material within the extruder). The pressure regulator may set the pressure to be greater than 300 psi (e.g., between 300-2000 psi, between 300-2500 psi), greater than 500 psi (e.g., between 500-2000 psi, between 500-2500 psi), or greater than 1000 psi (e.g., between 1000-2000 psi, between 1000-2500 psi) that of the blowing agent pressure downstream of the flow restrictor (and/or pressure of polymeric material within the extruder). At the end of the plastication process and the onset of the injection process, the controller may send an output signal to the pressure regulator to set the pressure of the blowing agent upstream of the flow restrictor to be below that of the blowing agent pressure downstream of the flow restrictor (and/or pressure of polymeric material within the extruder). The pressure regulator may reduce the pressure thereby setting the pressure to be less than 200 psi (e.g., between 200-500 psi), less than 300 psi (e.g., between 300-500 psi), or less than 500 psi (e.g., between 500-700 psi) that of the blowing agent pressure downstream of the flow restrictor (and/or pressure of polymeric material within the extruder). When blowing agent flow to the extruder is prevented, in some embodiments, the flow may be diverted through the return pathway and returned to the blowing agent source.

In some embodiments, the controller processes the input signals and compares the measured pressure differential across the flow restrictor to a desired pressure differential corresponding to a desired blowing agent amount (e.g., mass) and/or flow rate as calculated by the relationship determined during the calibration process described above. The controller may send an appropriate output signal to the upstream pressure regulator to adjust the upstream pressure of the flow restrictor, if necessary, to maintain the desired pressure differential. The flow rate and amount, thus, of blowing agent into the polymeric material within the extruder may be maintained at a selected value to create a mixture of polymeric material and blowing agent having a chosen percentage of blowing agent. Even when the pressure downstream of the flow restrictor changes, for example in response to pressure fluctuations within the polymeric material in the extruder, the introduction system may respond by adjusting the upstream pressure accordingly to provide the selected blowing agent amount and/or flow rate.

Though the blowing agent introduction system is illustrated as being used in conjunction with an injection molding system, it should be understood that the blowing agent introduction system may be used in conjunction with any polymer processing apparatus into which blowing agent is introduced. As noted above, the systems and methods may be particularly well suited for use with discontinuous polymer processes that have short molding cycle times. For example, the molding cycle times may be less than 15 seconds (e.g., between 1 second and 15 seconds, between 3 seconds and 15 seconds, etc.), less than 10 seconds, less than 8 seconds or less than 5 seconds. The minimum cycle time may be 1 second, 2 seconds or 3 seconds. As used herein, molding cycle time is used as generally known in the art and refers to the total time from removal of a first molded article from the mold to removal of a second molded article from the mold produced in a successive molding step. The molding cycle time includes the plastication period and the injection period, amongst other times periods, at times.

In general, the blowing agent introduction system may be used with the polymer processing system to produce any type of polymeric foam material. In some embodiments, the blowing agent introduction system may be used to introduce blowing agent into a polymer processing system that produces microcellular polymeric foam materials. In some embodiments, the microcellular polymeric foam materials produced may have an average cell size of less than 100 microns. It should be understood that polymeric foam materials having larger cell sizes may also be formed using the systems and methods described herein.

The blowing agent introduction system may be used to introduce blowing agent into polymeric material within the extruder over a wide range of different flow rates as required by the particular process. For example, the blowing agent mass flow rate is generally between about 5 mg/s and about 10 g/s and, in some cases between about 25 mg/s and about 2 g/s. The blowing agent is typically introduced into the polymeric material so as to provide the mixture with a desired blowing agent level. The desired blowing agent amount depends upon the particular process and is generally less than about 10% by weight of polymeric material and blowing agent. In many embodiments, the blowing agent level is less than about 5%, in others, less than about 3%, in others less than about 1%, in others less than about 0.5%, and still others less than about 0.1%, or even lower by weight of polymeric material and blowing agent mixture.

The blowing agent source may supply to the introduction system any type of physical blowing agent known to those of ordinary skill in the art including nitrogen, carbon dioxide, hydrocarbons, chlorofluorocarbons, noble gases and the like or mixtures thereof. The blowing agent may be supplied in any flowable physical state such as a gas, a liquid, or a supercritical fluid. According to one preferred embodiment, the source provides carbon dioxide as a blowing agent. In another preferred embodiment, the source provides nitrogen as a blowing agent. In certain embodiments, solely carbon dioxide or nitrogen is used. Blowing agents that are in the supercritical fluid state after injection into the extruder, (optionally, before injection as well) and in particular supercritical carbon dioxide and supercritical nitrogen, are preferred in certain embodiments.

The conduit of the blowing agent introduction system may be any of the type known in the art suitable for transporting blowing agent. For example, the conduit may be a tube made of a suitable material for transporting pressurized gas, liquefied gas, and/or supercritical fluid, such as a metal tube. In some cases, the conduit may be a stainless steel metal tube. In other embodiments, the conduit may be defined by passageways within a block of material, such as drill passageways within a block of metal, for example, stainless steel. The conduit typically has a cross-sectional diameter in the range of from about 1 cm to about 0.1 mm. However, it is to be understood, that the length and configuration of the conduit is not constrained and generally depends upon factors such as available manufacturing space, and the layout of the polymer processing and blowing agent introduction system. In some cases, it may be desirable to minimize the length of conduit, for example, to minimize pressure losses of blowing agent passing therethrough. In some cases, conduit may have one or more branches, for example, to facilitate connection to the various components.

In some embodiments, such as when the source does not supply blowing agent at a sufficiently high pressure, a pump 48 may be connected to an outlet of the source to increase and/or maintain the pressure of blowing agent in the introduction system. Generally, the blowing agent pressure within the introduction system is maintained at least above 1000 psi, and in many cases at least above 2000 psi. The maximum blowing agent pressure within the introduction system is generally less than 10,000 psi; in some cases, less than 5000 psi; and, in some cases, less than 3000 psi.

The temperature and pressure measuring devices and the pressure regulating devices used in blowing agent introduction system 10 may be any of the type known in the art. Suitable pressure measuring devices, for example, include pressure transducers. Suitable pressure regulators may control the pressure, in some embodiments, between about 500 psi and about 7000 psi. The pressure regulator may include a restriction which may be varied by moving an actuator, for example, in response to output signals from the controller.

Upstream pressure measurement device and pressure regulator may be positioned at any point upstream of the flow restrictor and downstream of the source, though generally the pressure measuring device is positioned between the regulator and the flow restrictor. In some embodiments, it may be preferably to position the upstream pressure measuring device and regulator proximate to the flow restrictor and/or proximate to one another to provide an accurate measurement of the pressure upstream of the flow restrictor by minimizing pressure losses through the conduit therebetween.

In general, the downstream pressure measurement device may be positioned at any point downstream of the flow restrictor and upstream of the blowing agent port(s). In some embodiments, it may be preferably to position the downstream pressure measuring device proximate to the flow restrictor to provide an accurate measurement of the pressure downstream of the flow restrictor by minimizing pressure losses through the conduit therebetween. In some embodiments, the distance between the downstream pressure measuring device and the flow restrictor may be between about 0.1 inches and about 12.0 inches.

As noted above, one advantage of the blowing agent introduction systems described herein is that blowing agent flow into the extruder is not controlled by a shut-off valve (e.g., a spring-loaded valve, the opening and closing of which may be air assisted) which is frequently opened and closed and, thus, subjected to wear conditions which can sacrifice performance. In such embodiments, the systems may not include any valve that is configured to open and close during a molding cycle and which is arranged between the flow restrictor and the blowing agent port(s) in the barrel of the extruder. However, in some embodiments, the blowing agent introduction systems may include a valve 39 (e.g., ball check valve) between the flow restrictor and blowing agent port(s) which is not configured to open and close during a molding cycle and/or is not configured to control the introduction of blowing agent into the extruder. In some embodiments, such a valve may be used to prevent back flow of polymeric material out of the extruder.

The controller may be any of the type known in the art such as a computer. As described above, the controller is capable of receiving input signals (e.g., from the pressure measuring devices, temperature measuring devices, input signals relating to screw position and rotation) and sending appropriate output signals (e.g., to upstream pressure regulator). In some embodiments, input signals may be received by the controller continuously and output signals may be sent by the controller continuously and simultaneously (e.g., within real time). In other cases, the input signals and the output signals may be respectively received and sent continuously. The rate at which the input signals are received need not match the rate at which the output signals are sent. For example, the input signals may be received continuously, while the output signals may be provided at an interval.

In general, the flow restrictor has a pathway through which blowing agent flows and may be provided in any suitable structure. In some embodiments, the dimensions of the pathway may be fixed. That is, the pathway dimensions are not changeable. For example, the flow restrictor may be formed as a hole through a block. In some embodiments, the flow restrictor may be interchangeable with another flow restrictor to provide the introduction system with the capability of utilizing a flow restrictor with different dimensions. The hole may be an annular bore having a constant cross-section for its entire length. Annular bores may be utilized because they are easily machined, though holes having other geometries may also be used. In some embodiments, the flow restrictor has a pathway that has a variable dimensions. For instance, the diameter of the flow pathway may be changed as desired for different processes. The specific dimensions of the flow restrictor (whether fixed of variable) may be dependent upon the blowing agent introduction requirements of a particular process. In some embodiments, the pathway may have a length L of between about 0.010 inches and about 0.040 inches, a diameter D of between about 0.001 inches and about 0.01 inches, and a L/D (length/diameter) ratio of between about 1:1 and about 6:1.

It should be understood that other types of flow restrictors may be used in the introduction system.

What is claimed:

1. A method of discontinuously introducing blowing agent into a discontinuous polymer foam processing system including an extruder comprising:
providing a source configured to supply blowing agent to a flow restrictor of a blowing agent introduction system;
measuring blowing agent pressure upstream of the flow restrictor and downstream of the flow restrictor;
changing pressure of the blowing agent upstream of the flow restrictor using a pressure regulator to control introduction of blowing agent into polymeric material in the extruder of the discontinuous polymer foam processing system;
wherein blowing agent is introduced into the polymeric material in the extruder when the pressure of the blowing agent upstream of the flow restrictor is greater than the pressure of the blowing agent downstream of the flow restrictor and blowing agent is not introduced into the polymeric material in the extruder when the pressure of the blowing agent upstream of the flow restrictor is less than the pressure of the blowing agent downstream of the flow restrictor.

2. A method according to claim 1, further comprising conveying polymeric material in a downstream direction in the extruder.

3. A method according to claim 1, further comprising injecting polymeric material through an outlet of an extruder into a mold.

4. A method according to claim 1, wherein blowing agent is introduced into the polymeric material in the extruder during at least a portion of the plastication period of a molding cycle.

5. A method according to claim 1, wherein the molding cycle time is between 3 seconds and 15 seconds.

6. A method according to claim 1, wherein blowing agent is not introduced into the polymeric material in the extruder during an injection period of a molding cycle.

7. A method according to claim 1, further comprising diverting blowing agent flow to the extruder through a passageway back to the source.

8. A method according to claim 1, further comprising measuring blowing agent temperature proximate the flow restrictor.

9. A method according to claim 1, wherein the flow restrictor comprises a hole.

10. A method according to claim 1, further comprising calculating the rate and/or amount of blowing agent flow through the flow restrictor in response to inputs of the blowing agent pressure upstream of the flow restrictor and downstream of the flow restrictor.

11. A method according to claim 1, further comprising calculating the rate and/or amount of blowing agent flow through the flow restrictor in response to inputs of blowing agent temperature.

12. A polymer foam processing system comprising:
a blowing agent source;
a blowing agent introduction system connected to the blowing agent source and including:
a flow restrictor;
a pressure regulating device upstream of the flow restrictor;
a pressure measuring device upstream of the flow restrictor;
a pressure measuring device downstream of the flow restrictor; and
an extruder including a screw constructed and arranged to rotate within a barrel to convey polymeric material in a downstream direction, the barrel having a blowing agent port formed therein; and
a mold connected to an outlet of the extruder,
wherein the blowing agent introduction system is configured to introduce blowing agent into the polymeric material in the extruder when the pressure of the blowing agent upstream of the flow restrictor is greater than the pressure of the blowing agent downstream of the flow restrictor and blowing agent is not introduced into the polymeric material in the extruder when the pressure of the blowing agent upstream of the flow restrictor is less than the pressure of the blowing agent downstream of the flow restrictor.

13. A system according to claim 12, wherein blowing agent is introduced into the polymeric material in the extruder during a plastication period of a molding cycle.

14. A system according to claim 12, wherein the molding eycle time is between 3 seconds and 15 seconds.

15. A system according to claim 12, wherein blowing agent is not introduced into the polymeric material in the extruder during an injection period of a molding cycle.

16. A system according to claim 12, further comprising a passageway constructed and arranged to divert blowing agent flow from the extruder to the source.

17. A system according to claim 12, further comprising a temperature measuring device constructed and arranged blowing agent temperature proximate the flow restrictor.

18. A system according to claim 12, wherein the flow restrictor comprises a hole.

19. A system according to claim 12, further comprising a controller configured to adjust the upstream pressure regulating device.

20. A system according to claim 12, wherein the controller is configured to adjust the upstream pressure regulating device in response to inputs from the pressure measuring device upstream the flow restrictor and the pressure measuring device downstream the flow restrictor.

21. A system according to claim 12, wherein the controller is configured to adjust the upstream pressure regulating device in response to inputs from temperature measuring device.
